(19) United States
(12) Patent Application Publication
(10) Pub. No.: US 2008/0177582 A1
(43) Pub. Date: Jul. 24, 2008

(54) LIFE SETTLEMENT METHOD AND APPARATUS

(75) Inventors: Michael O'Brien, Ellicott City, MD (US); John McPherson, Baltimore, MD (US); Sam Beritela, Sparks, MD (US); Michael Quinn, Baltimore, MD (US)

Correspondence Address: DLA PIPER US LLP;ATTN: PATENT GROUP, 500 8th Street, NW, WASHINGTON, DC, 20004-2131, US

(73) Assignee: CIELO CAPITAL MANAGEMENT, LLC, Baltimore, MD (US)

(21) Appl. No.: 12/015,108

(22) Filed: Jan. 16, 2008

Related U.S. Application Data
(60) Provisional application No. 60/885,071, filed on Jan. 16, 2007.

(51) Int. Cl. G06Q 40/00

(52) U.S. Cl. 705/4

(57) ABSTRACT

Methods and devices for reducing costs associated with life settlement transactions include an initial economic evaluation and a targeted but abbreviated verification of information provided by a potential customer and gathering of additional information, followed by a conditional offer for those policies that satisfy the economic criteria (e.g., face value of policy, stated life expectancy, etc.) and for which the abbreviated verification is positive. The verification and additional information may be performed by one or more of following: 1) a query of a prescription database in which the identity and use of the prescription drugs identified by the customer are determined; 2) a questionnaire filled out by a physician treating the patient for a particular illness; and 3) a telephone inquiry of the insured. If the additional information and verification are consistent with the initial information, the life settlement is completed.

This application claims priority from U.S. Provisional Application Ser. No. 60/885,071 filed Jan. 16, 2007. The entirety of that provisional application is incorporated herein by reference.

### BACKGROUND

A life settlement is the purchase of an in-force life insurance policy from the policy owner (known as the viator) for an amount greater than the policy's cash surrender value and the assumption of responsibility for future premium payments in exchange for entitlement to the policy's death and cash surrender benefits. The life settlement industry is large and growing in the U.S. The estimated face value of life settlements transacted in 2005 is between $10 billion and $15 billion, which consumed between $3.5 billion and $5 billion in investment capital. Despite the size of this market, there is a huge but largely untapped potential market for life settlements of small face value insurance policies (those with face values less than $500,000 and, in particular, those with face values in the range of $50,000-$250,000). At the present time, life settlements for policies having a face value of less than $250,000 constitute less than 1% of all life settlements, yet these policies represent in excess of 83% of existing life insurance policies.

One of the primary reasons that this market has been long underserved is the high transaction costs associated with life settlements using traditional methods. Thus, what is needed is a more cost effective method that reduces costs associated with traditional methods.

### SUMMARY

Methods and devices for reducing costs associated with life settlement transactions include an initial economic evaluation and a targeted but abbreviated verification of information provided by a potential customer and gathering of additional information, followed by a conditional offer for those policies that satisfy the economic criteria (e.g., face value of policy, stated life expectancy, etc.) and for which the abbreviated verification is positive. In some embodiments, the abbreviated additional information gathering and verification includes one or more of following: 1) a query of a prescription database in which the identity and use of the prescription drugs identified by the customer are determined (in some embodiments, the refill dates of the customer's prescription are compared against the intended refill dates); 2) a questionnaire filled out by one or more of the physicians who are treating the patient for a life-threatening illness or a most serious illness (it should be noted that the invention is not limited to customers with life threatening illnesses), where the questionnaire includes requests for more detailed information than that information provided by the customer; and 3) a telephone inquiry of the insured to gather more detailed information based on the information provided by the customer. If the abbreviated verification is positive (and, in some embodiments, a revised life expectancy calculated using additional data discovered during the abbreviated verification indicates that a life settlement remains viable), the conditional offer is made. The conditional offer is conditioned upon verification of the accuracy of the information provided by customer. If the conditional offer is accepted, a more extensive verification of the information provided by the customer is conducted. If the more extensive verification confirms that the information provided by the customer is correct, the life settlement transaction is completed.

### BRIEF DESCRIPTION OF THE DRAWINGS

FIG. 1 is a block diagram of a life settlement system according to one embodiment of the invention.

FIG. 2 is a flow diagram illustrating processing performed by the life settlement system of FIG. 1 in an embodiment of the invention.

FIG. 3 is a screen shot illustrating a first web page provided by the server of the system of FIG. 1 in an embodiment of the invention.

FIG. 4 is a screen shot illustrating a second web page provided by the server of the system of FIG. 1 in an embodiment of the invention.

FIG. 5 is a screen shot illustrating a third web page provided by the server of the system of FIG. 1 in an embodiment of the invention.

FIGS. 6a, 6b and 6c are screen shots illustrating a fourth web page provided by the server of the system of FIG. 1 in an embodiment of the invention.

FIG. 7 is a screen shot illustrating a fifth web page provided by the server of the system of FIG. 1 in an embodiment of the invention.

FIG. 8 is a screen shot illustrating a sixth web page provided by the server of the system of FIG. 1 in an embodiment of the invention.

FIG. 9 is a screen shot illustrating a seventh web page provided by the server of the system of FIG. 1 in an embodiment of the invention.

FIGS. 10a through 10j illustrate a written questionnaire provided by the sever of FIG. 1 in an embodiment of the invention.

FIGS. 11a-11c illustrate a disclosure statement provided by the server of FIG. 1 in an embodiment of the invention.

FIGS. 12 and 13 illustrate a disclosure brochure provided by the server of FIG. 1 in an embodiment of the invention.

FIG. 14 illustrates an insurance information release form provided by the server of FIG. 1 in an embodiment of the invention.

FIG. 15 illustrates a medical information release form provided by the server of FIG. 1 in an embodiment of the invention.

### DETAILED DESCRIPTION

The present invention will be discussed with reference to preferred embodiments of life settlement systems and methods. Specific details, such as are set forth in order to provide a thorough understanding of the present invention. The preferred embodiments discussed herein should not be understood to limit the invention. Furthermore, for ease of understanding, certain method steps are delineated as separate steps; however, these steps should not be construed as necessarily distinct nor order dependent in their performance.

In one embodiment, a customer requests and completes a questionnaire that includes detailed information concerning the customer's identification information, identification information concerning the owner of the policy (if the customer is not the owner), the customer's medical information including life expectancy and/or identification of any life threatening illnesses, and information about the life insurance policy for which the life settlement is being sought (face value, expiration date, surrender value, length of time the policy has been in force, existence of loans on the policy, etc.). In such embodiments, the questions in the questionnaire concerning the customer's medical information are intended to provide sufficient information for the determination of a preliminary life expectancy. The inventors have learned through practical experience that the questions in the medical questionnaire are often not answered with sufficient particularity in order to allow a preliminary life expectancy to be calculated. Therefore, it is sometimes necessary in such embodiments to perform a telephone interview with the insured in order to gather this information. In recognition of this problem, other embodiments of the invention employ a questionnaire with abbreviated medical questions, and a telephone interview with the insured is automatically performed in order to gather the information necessary to determine the preliminary life expectancy. This information from the questionnaire and, if necessary, from the initial follow up phone interview, is used to perform an initial suitability analysis, which includes verifying the suitability of the policy for a life settlement, determining a preliminary life expectancy, and determining the economic feasibility of a life settlement.

If the initial suitability analysis is positive, a portion of the customer's medical information (preferably only that information pertaining to a particular life-threatening illness or a most serious illness) is verified, and additional information is gathered, using one or more of three methods as discussed above: a query of the prescription database to determine the insured's use of prescription drugs (which can verify that medications listed by the customer have been dispensed to the customer and determine how frequently the customer's prescriptions have been refilled); a questionnaire (which can be written or by telephone) completed by the insured's physician or physicians (in some embodiments, the physician treating the patient for the life-threatening illness); or a telephone inquiry with the insured. The aforementioned techniques are used in some embodiments to gather additional information based on the initial information provided by the customer in the original questionnaire. For example, if the initial information indicates that the customer is a diabetic, then additional questions specific to diabetes are asked to obtain additional information. Such additional information can include the type of diabetes, whether the prescription drugs initially identified by the customer are being used compliantly (readings, hospital admittance, date prescription last filled, and other factors all help in determining the answer to this question). In those instances where the questionnaire did not include enough information to determine a preliminary life expectancy (e.g., because the questionnaire was not properly completed or because the abbreviated questionnaire was used) and a telephone interview with the insured is necessary, a single telephone interview in which the information necessary for the preliminary life expectancy and the additional information discussed in this paragraph is performed. In such instances, the telephone interview will be terminated before the detailed additional information is gathered if the insured's responses indicate that the insured is not a suitable candidate for a life settlement.

The results are used to determine a revised life expectancy in some embodiments, and to determine an amount of a conditional offer to the customer. The amount of the conditional offer can be determined using traditional underwriting techniques. If the customer accepts the conditional offer, then a more extensive verification of the information provided by the customer is conducted. This more extensive verification can include attending physician statements, confirming the policy status of the insured with the insurance carrier, and preparing the necessary documentation to effect change of ownership and beneficiary with the insurance carrier. A traditional, full underwriting is performed in some embodiments (e.g., where the life settlement may be sold in a secondary market). As discussed above, a significant cost reduction is achieved because this costly full underwriting is only performed for those who have accepted the conditional offer. In other embodiments, the traditional full underwriting is omitted.

In preferred embodiments, the method described above is performed with the use of agents, who can be life insurance agents, brokers, life settlement providers, or others. The agent directly interfaces with the customer, collects information from the customer, explains available options to the customer, and facilitates closing of the settlement transaction. The underwriting information (i.e., the life expectancy) is preferably not shared with the agent in order to prevent the agent from “shopping” the settlement to others. Rather, the underwriting activities are preferably paid for and retained by the entity making the life settlement offer.

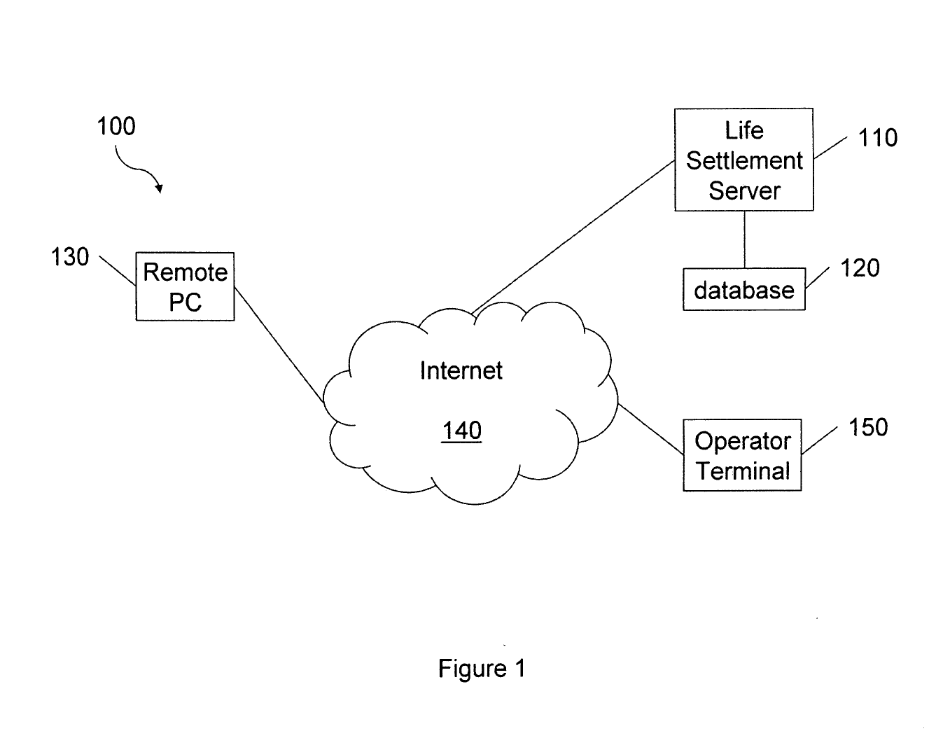

The invention also includes an apparatus 100 that facilitates the methods discussed above. The apparatus preferably includes server 110 connected to a database 120 for storing customer information and, in some embodiments, includes a graphical user interface through which the agent or insured can enter the information, preferably using a remote PC 130 connected to the server 110 over the Internet 140 as shown in FIG. 1. The database 120 can also store information including underwriting data and sound recordings or images of the verification process (e.g., the physician or insured telephone interview or written questionnaire, etc.). The apparatus preferably further includes a terminal 150 (which may take the form of a PC or other device) connected to the server 110 via the Internet 140 (or via a direct or LAN connection) through which an operator can enter information such as the results of an insured or physician interview or other information. In some embodiments, the apparatus 100 also performs the initial economic evaluation automatically based on the entered customer information.

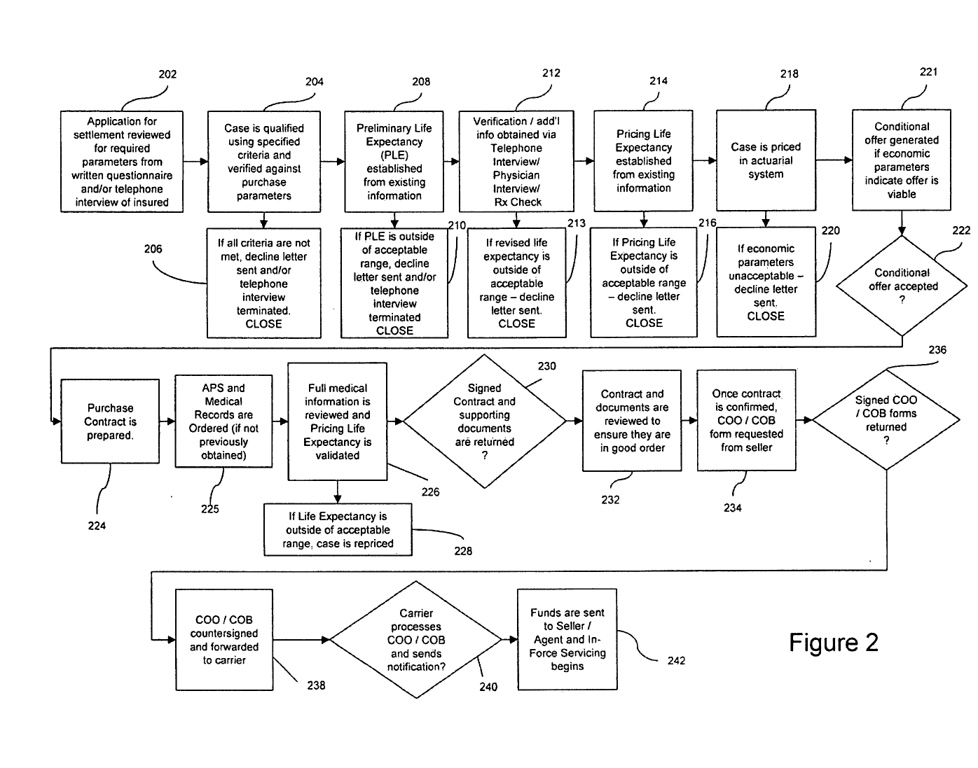

Operation of the apparatus 100 in a preferred embodiment will now be discussed in connection with the flow diagram 200 of FIG. 2. The process starts with the server 110 inputting information from an application and reviewing that information for the presence of required parameters at step 202. The application information may be obtained entirely from a “written” (where “written” should be understood to include information entered on an electronic form) questionnaire input to the server 110 from the remote PC 130 (which may be from an agent, an insured, or any other source), or may be input partially from the written questionnaire and partially from the operator terminal 150. As discussed above, in situations where sufficient information is not present on a written questionnaire, the server 110 may signal an operator to perform a telephone interview with the insured and enter the information necessary i) to determine whether the policy satisfies the minimum criteria for a life settlement, and (ii) to generate the preliminary life expectancy via the operator terminal 150.

When the required parameters are present, the application is initially qualified as suitable for a life settlement using a basic set of criteria (e.g., amount of policy, life expectancy stated on questionnaire, etc.) at step 204. If these basic criteria are not met, the server 110 generates a decline letter or terminates the in-progress telephone interview at step 206. If the basic criteria are met, the server 110 generates a preliminary life expectancy at step 208. If the preliminary life expectancy is outside of an acceptable range, the server 110 generates a decline letter or terminates the telephone interview with the insured at step 210. In some embodiments, the preliminary life expectancy must satisfy both minimum and maximum criteria. The minimum criterion may be, for example, two years. For life expectancies below this minimum, the insured may be directed toward a viatical provider. The maximum criterion may be, for example, 12 years. Life expectancies above twelve years are typically not economically viable for a life settlement due to the length of time the premium payments must be made.

If the preliminary life expectancy criteria are satisfied at step 208, then additional information is gathered at step 212 via a telephone interview with the insured (which may be a continuation of an interview started to obtain the information necessary for step 202), a physician interview (either telephonic or written), or a prescription check as discussed above. If any of the additional information indicates that a life settlement is not viable (e.g., a revised life expectancy based on the information is outside of the aforementioned acceptable range), a decline letter is sent at step 213. Otherwise, a pricing life expectancy using this additional information is calculated at step 214. If the pricing life expectancy is outside the parameters discussed above, the server 110 generates a decline letter at step 216. If the pricing life expectancy is within the aforementioned parameters, the application is priced using an actuarial module (which may be a subroutine in the server 110 or may be performed by a third party such as a life settlement funder) at step 218. This price from the actuarial module is used to perform an economic analysis to determine if the price calculated satisfies one or more required economic parameters (e.g., a minimum rate of return). If the economic parameters are not satisfied, the server 110 generates a decline letter at step 220. If the economic parameters are satisfied, the server 110 generates a conditional offer based on the price generated by the actuarial module at step 221.

If an indication that the conditional offer indication has been accepted (which may come from the remote PC 130 or the operator terminal 150) is received at the server 110 at step 222, the server 110 prepares a purchase contract at step 224 and generates an order for an APS (attending physician statement) and/or medical records at step 225. The full medical information (i.e., the APS and the medical records together with all other available information) is reviewed to determine consistency with the information used to generate the conditional offer, and the life expectancy used to price the conditional offer is validated, at step 226. If the full medical information differs from the information used to generate the offer to such an extent that a life expectancy calculated using the full medical information is outside an acceptable range at step 228, the application is re-priced and a revised conditional offer is generated and verified if accepted by repeating steps 218 and following.

If the life expectancy calculated using the full medical information is within acceptable parameters, the purchase contract generated at step 224 is sent to the agent/insured and, if an indication that they have been returned is received at step 230, the documents are reviewed (which may be done manually by an operator and an indication entered via the operator terminal 150) at step 232. Next, the server 110 signals the agent or other personnel to request change of beneficiary (COB) and/or change of owner (COO) forms from the owner of the policy at step 234. If an indication that the COB/COO forms have been returned is received at step 236, the server 110 signals an operator that the forms are to be countersigned and forwarded to the life insurance policy carrier at step 238. If the server 110 receives an indication that the COB/COO forms have been accepted from the carrier at step 240, the server 110 authorizes the release of funds and generates a notice to an entity responsible for in-force servicing. In-force servicing comprises making required premium payments on the policy and periodically checking to ensure that the insured is not deceased and, when necessary, filing the required claim forms with the life insurance carrier. It should be understood that the server is configured to track in-force servicing in some embodiments.

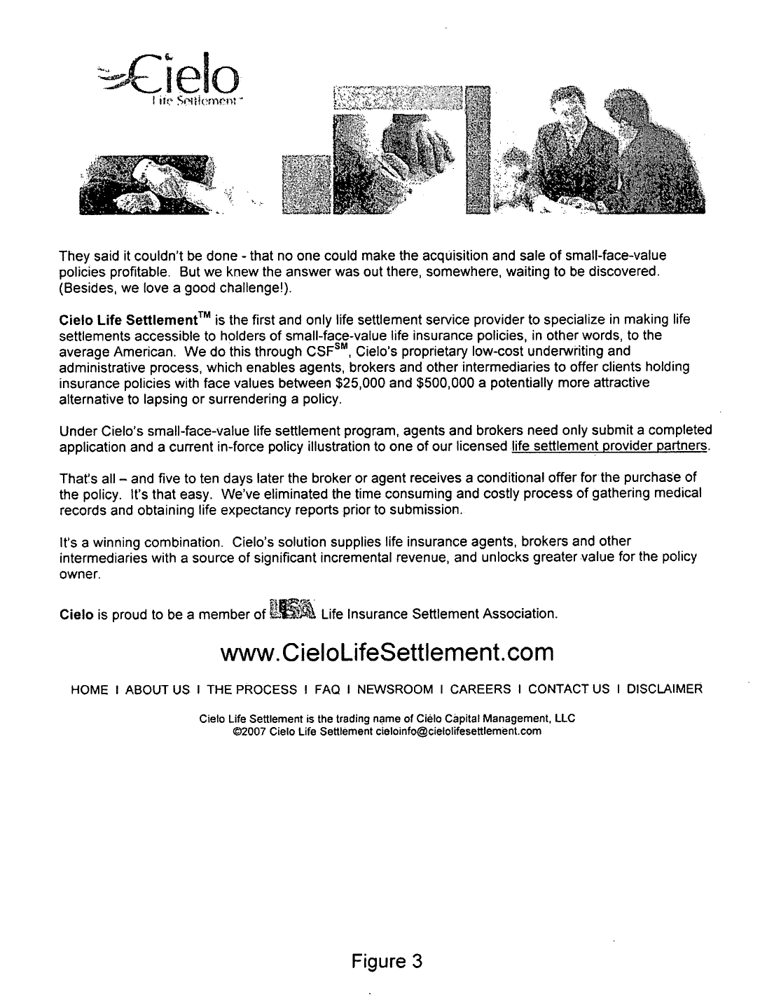

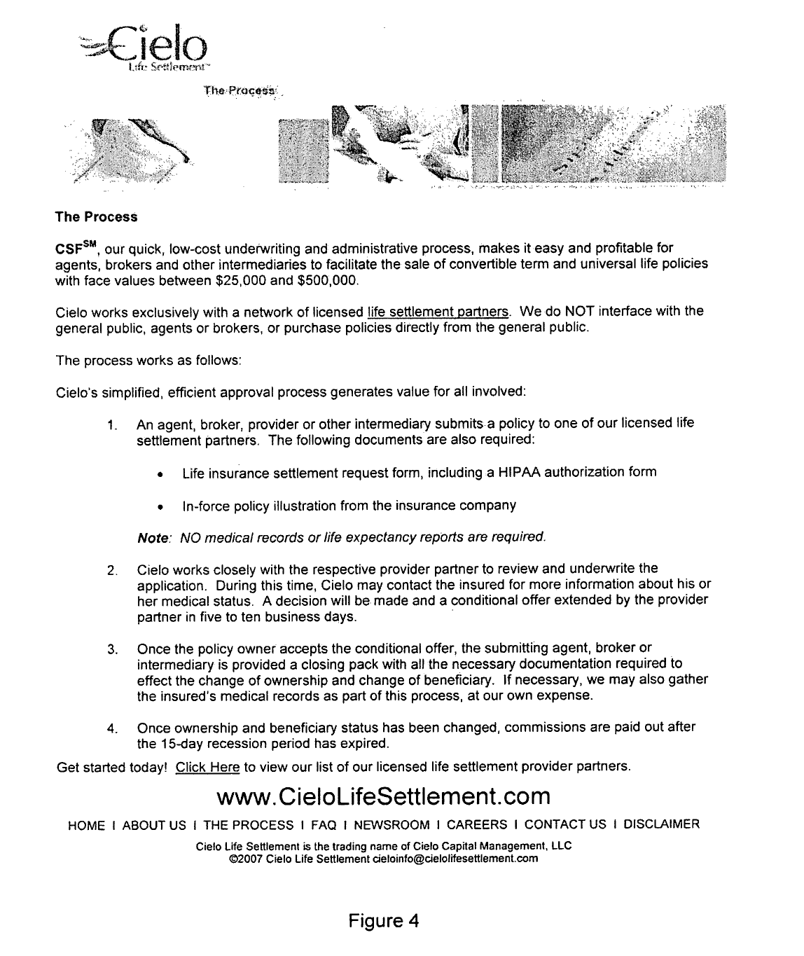

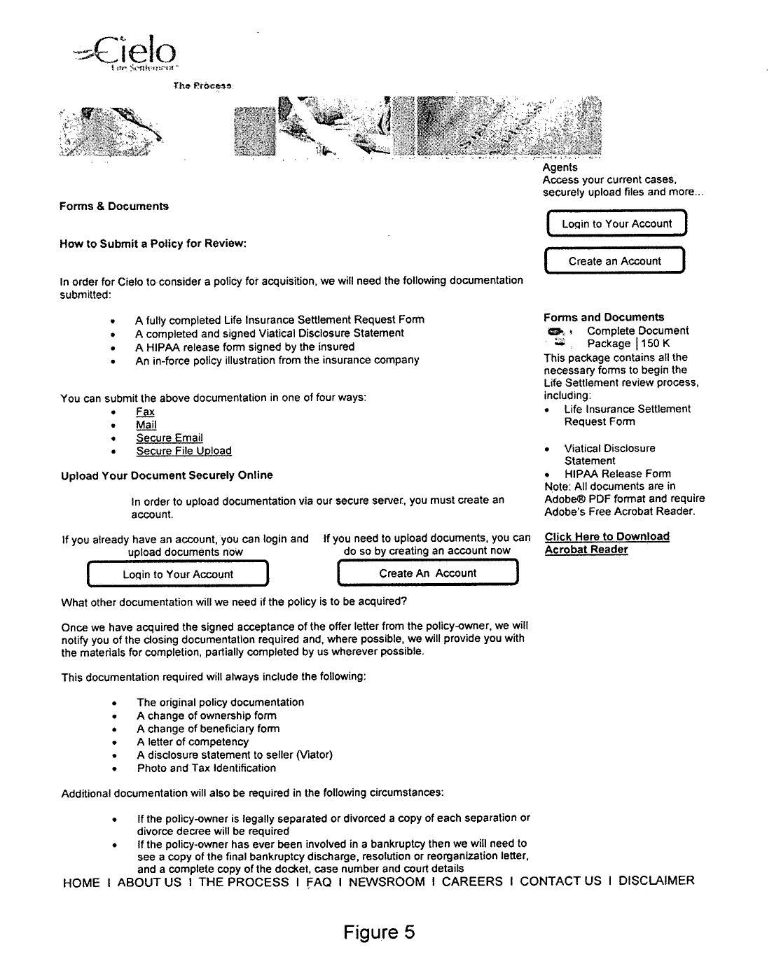

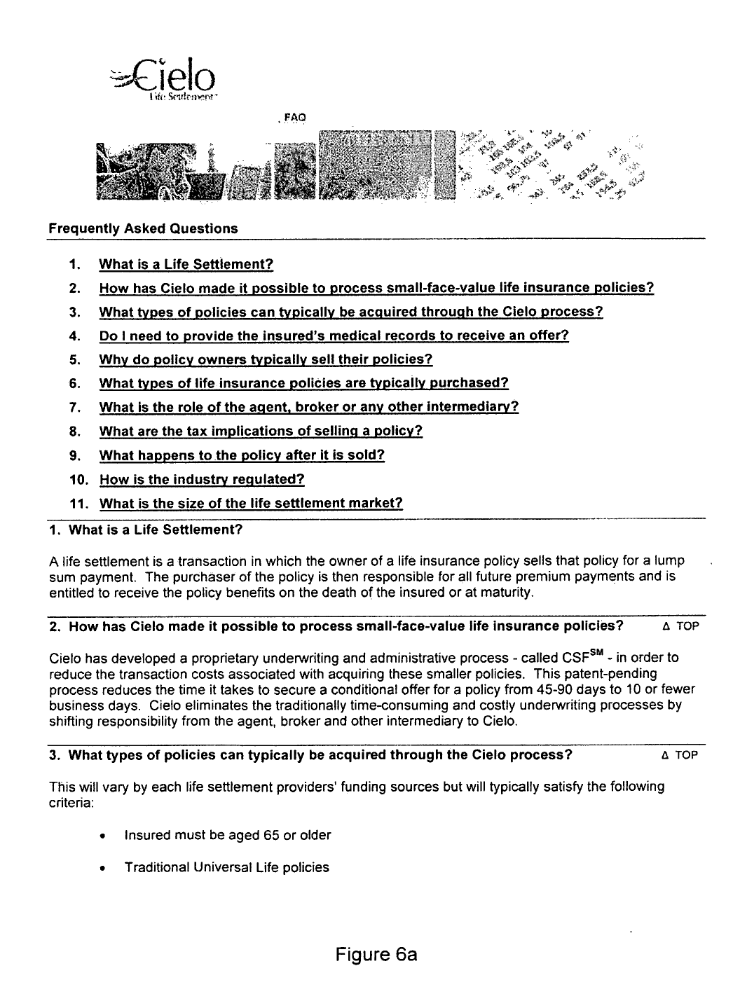

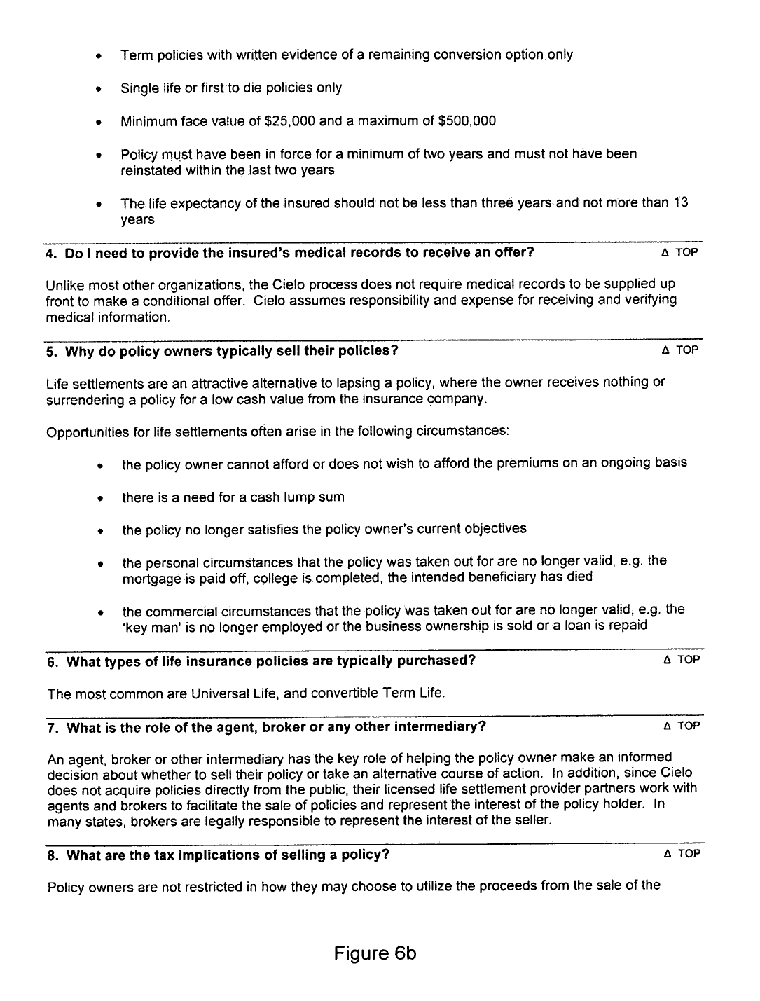

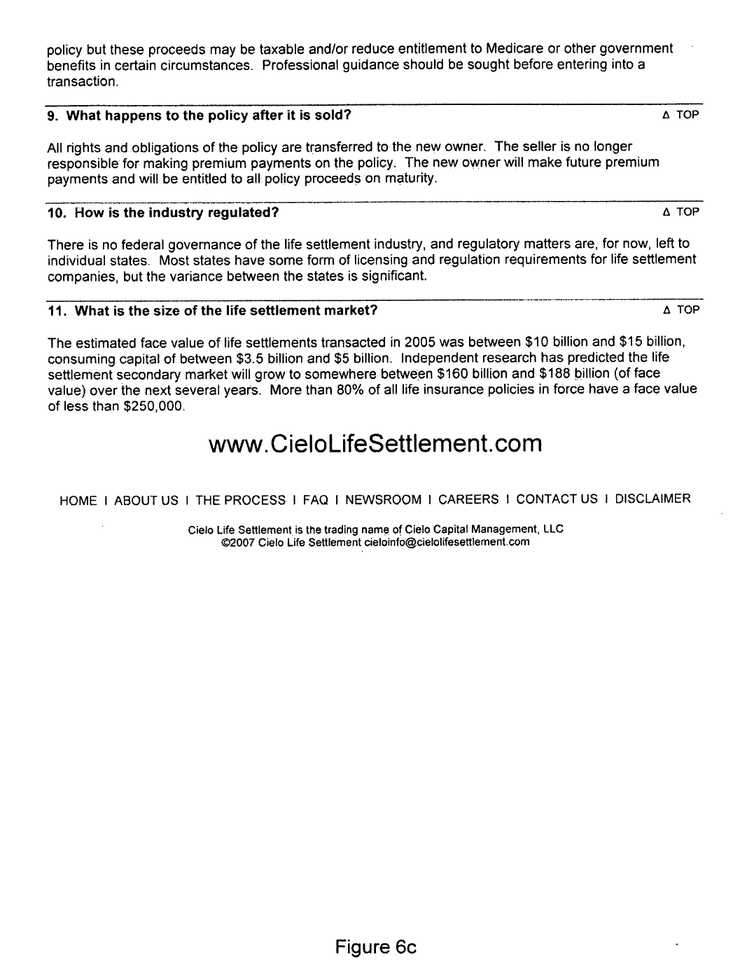

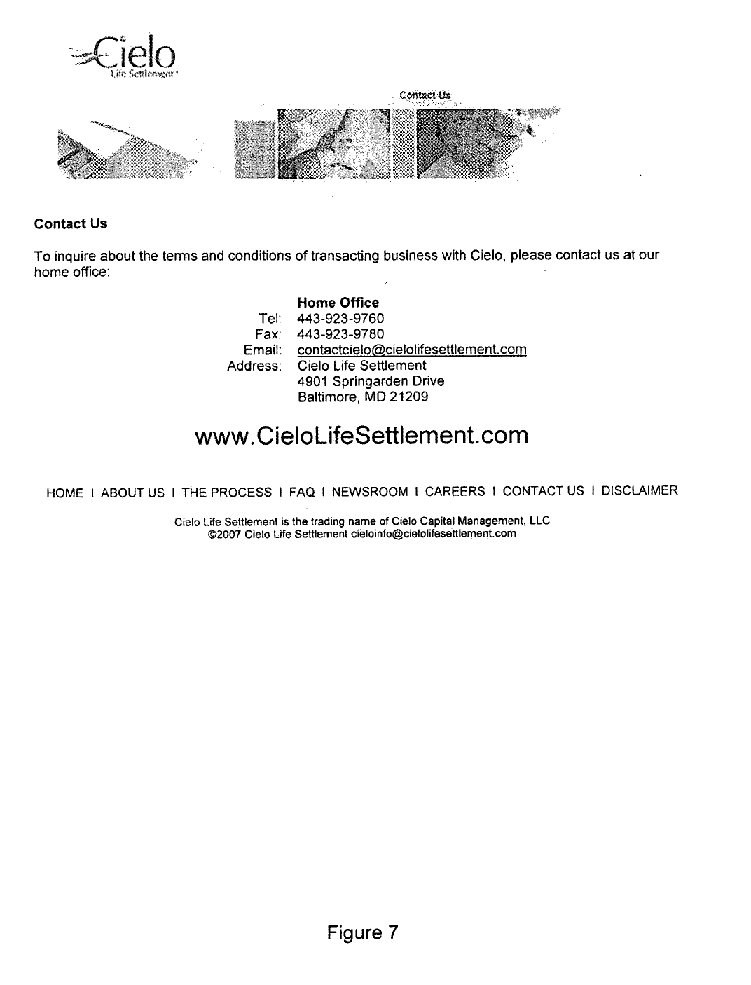

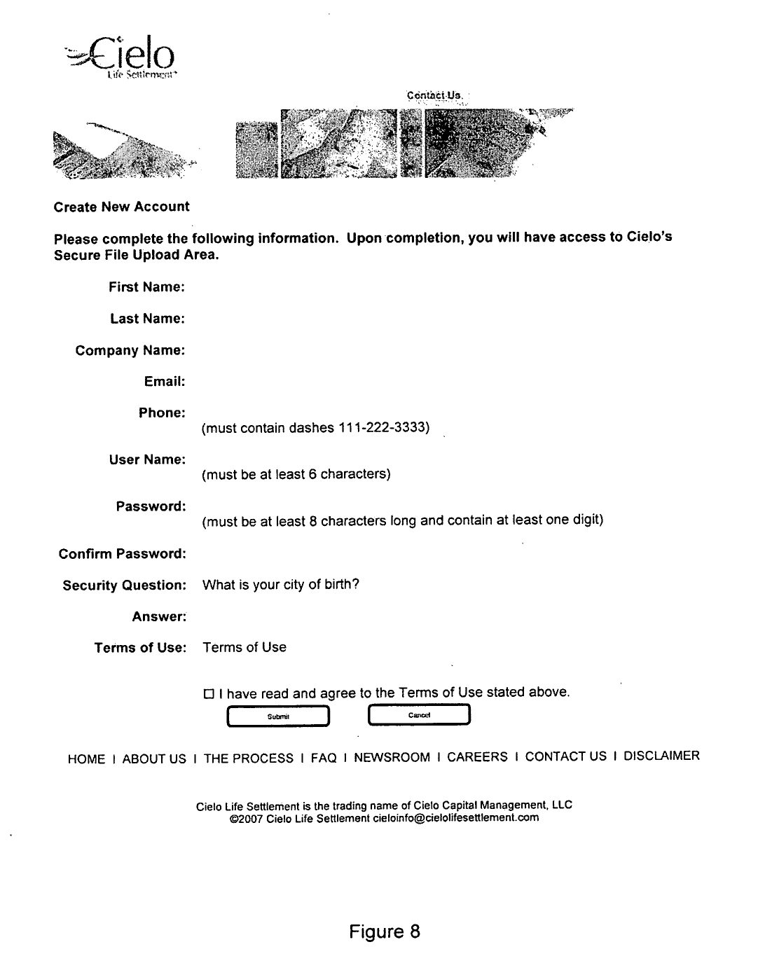

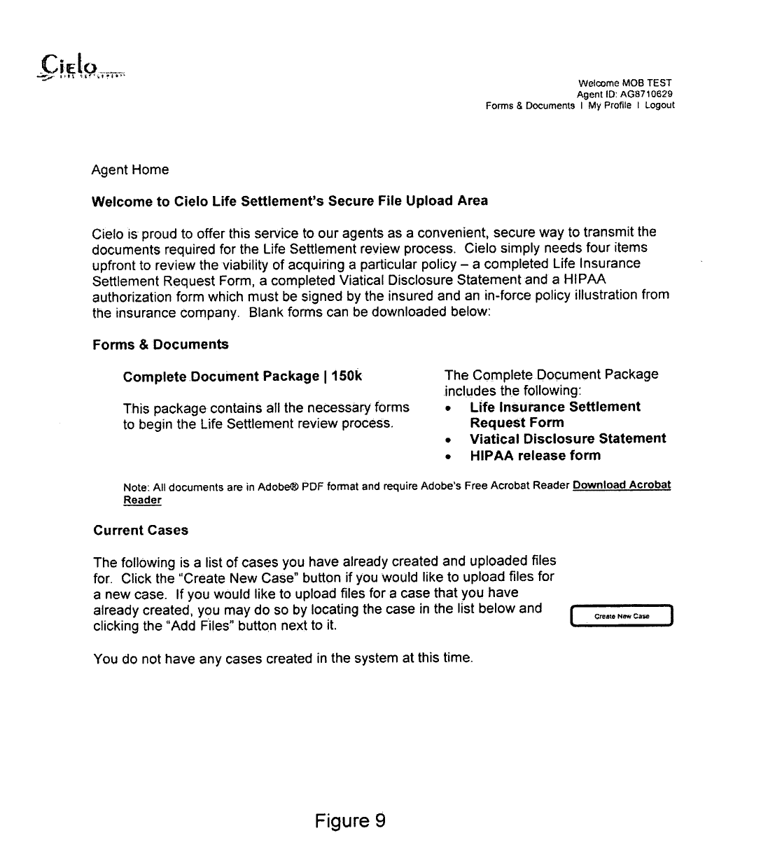

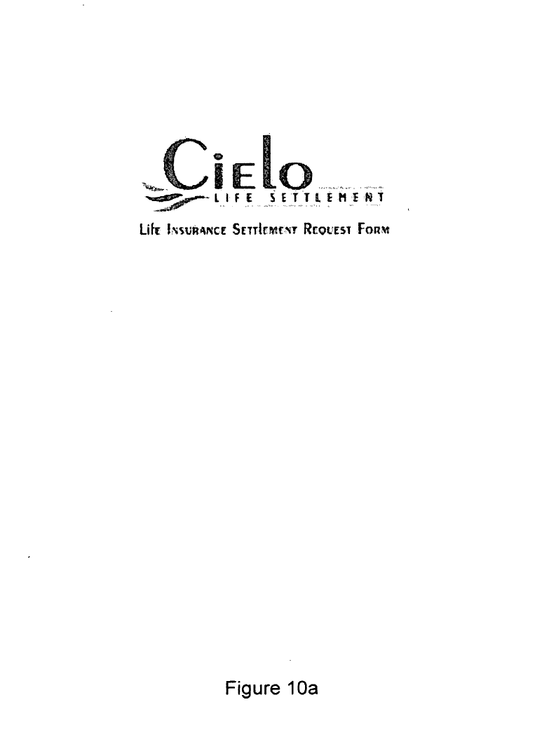

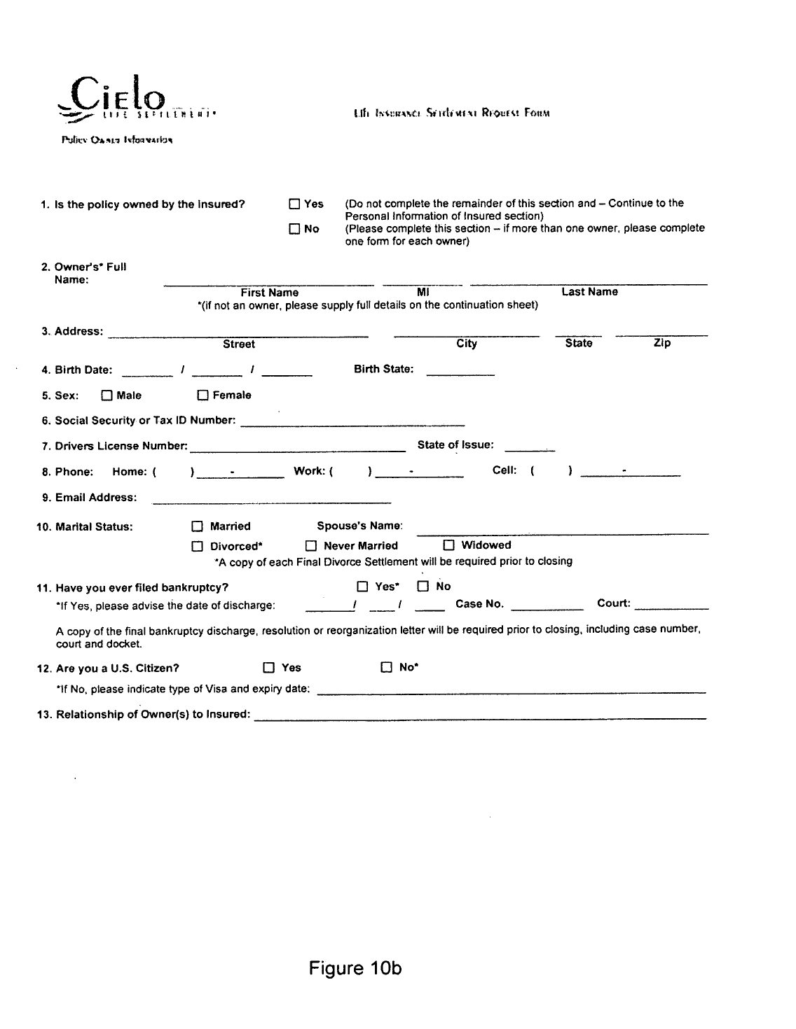

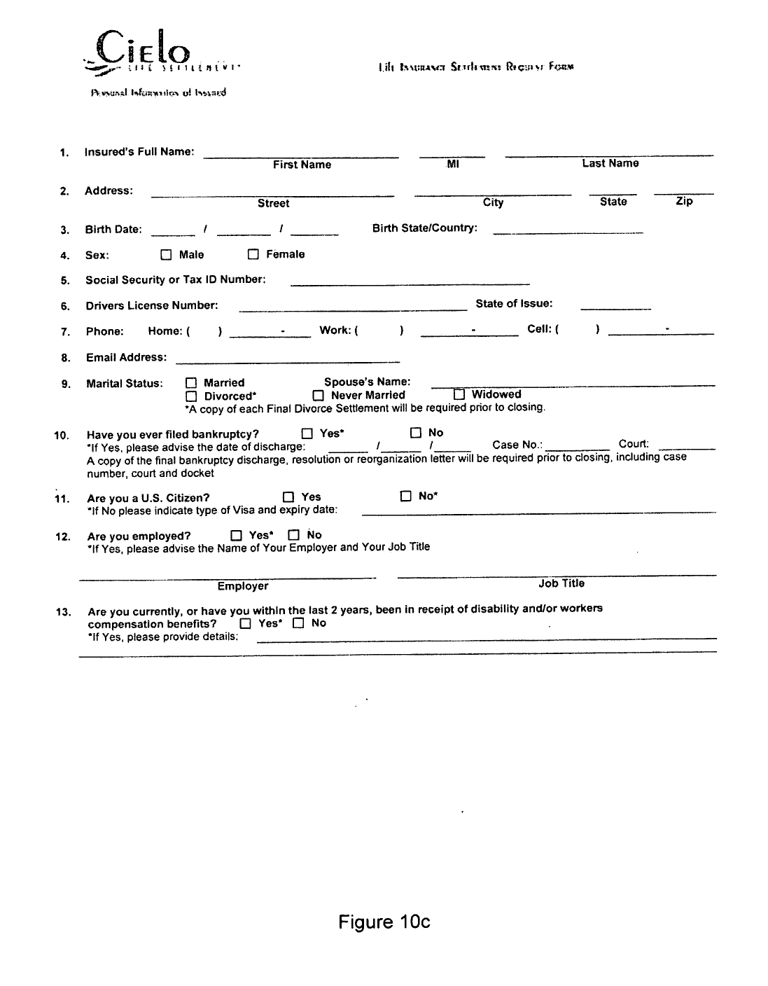

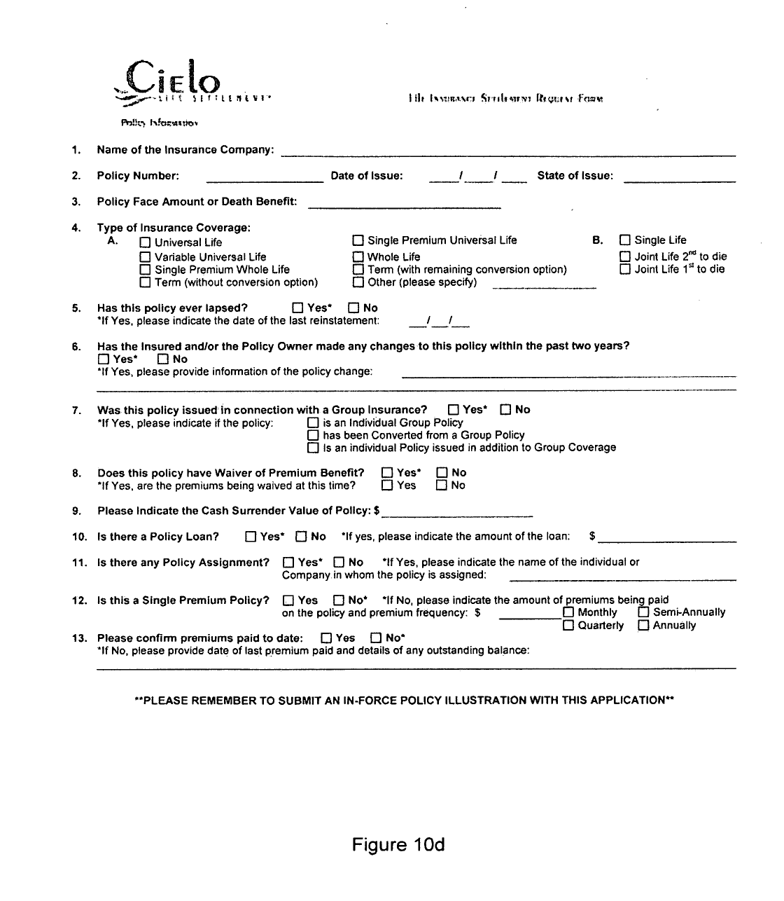

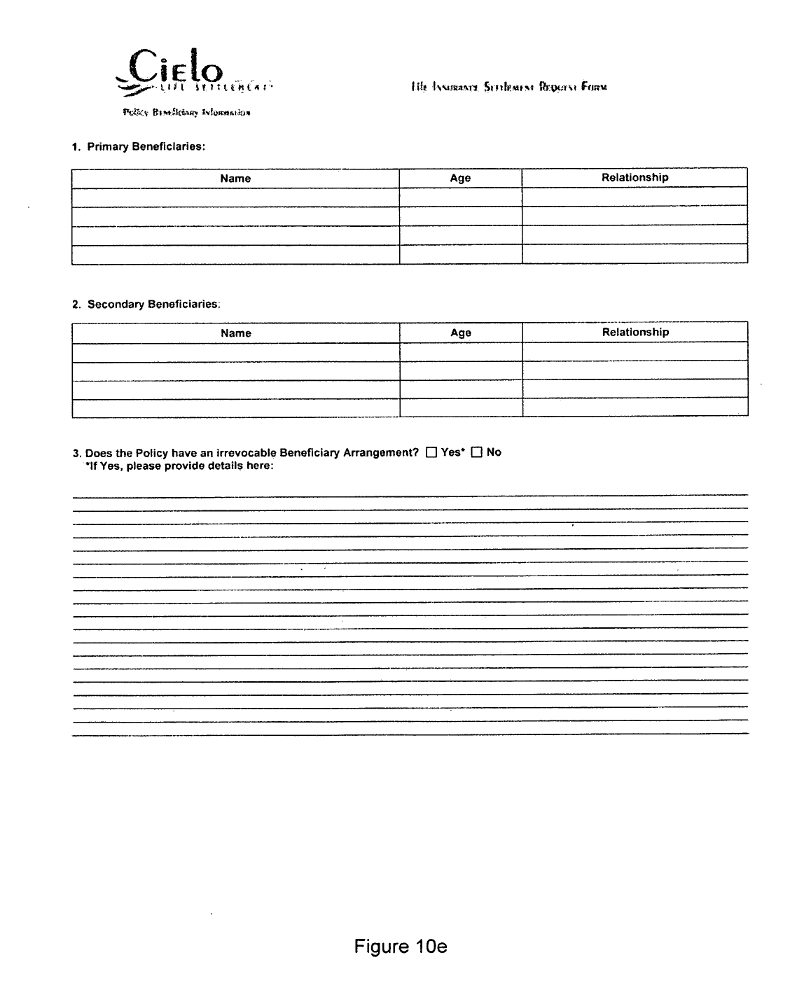

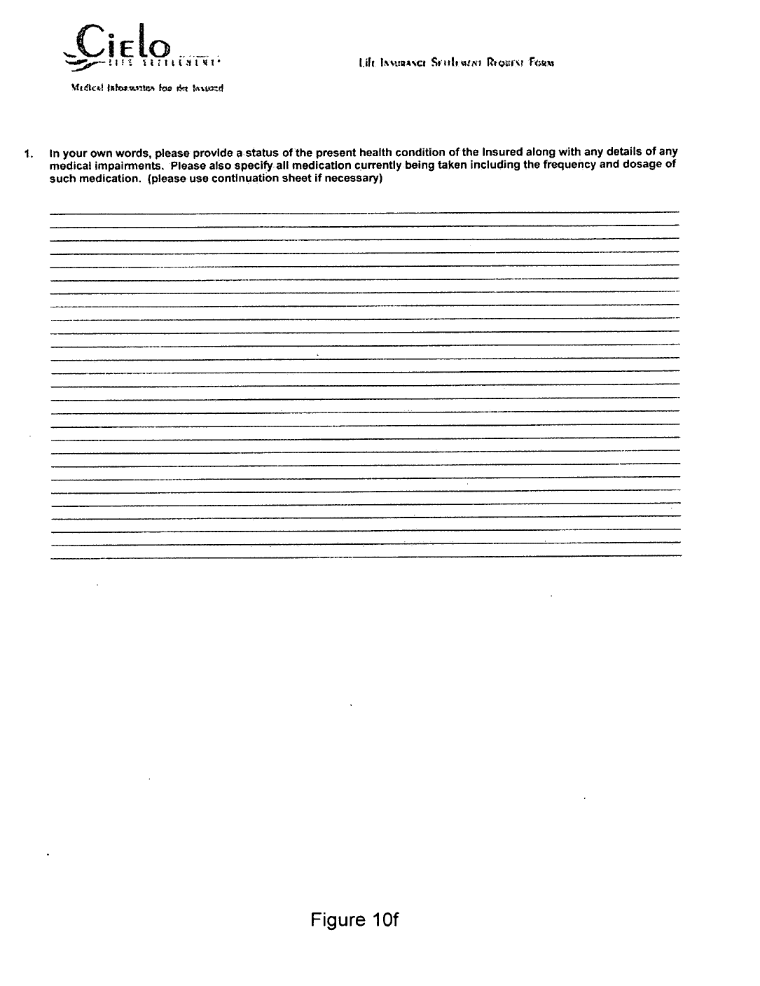

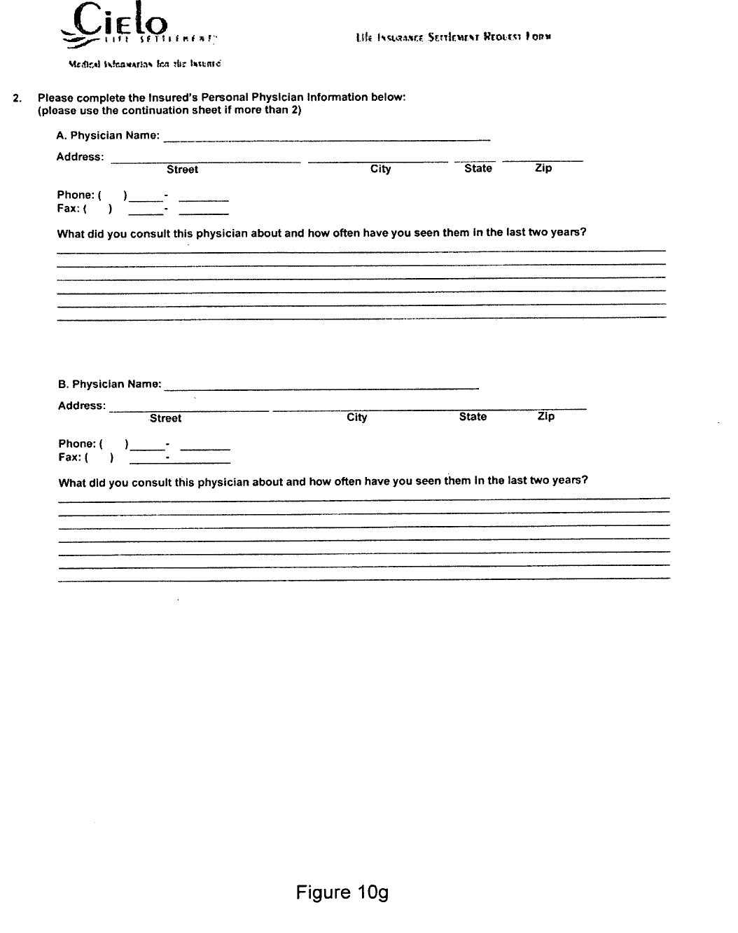

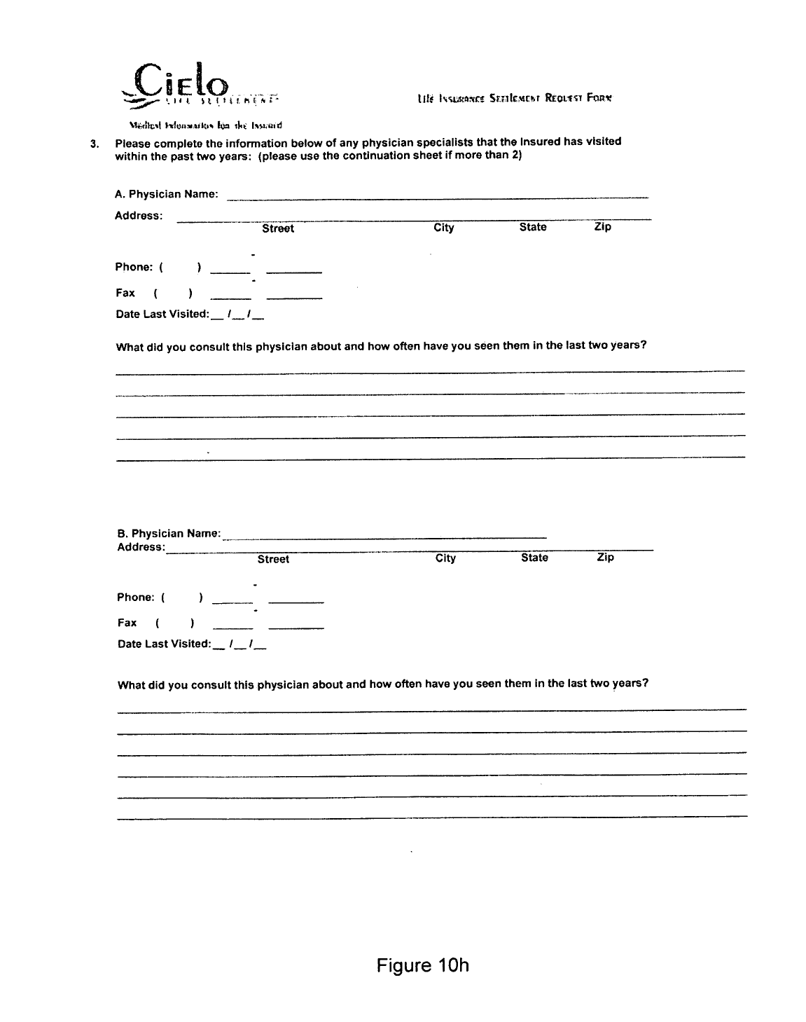

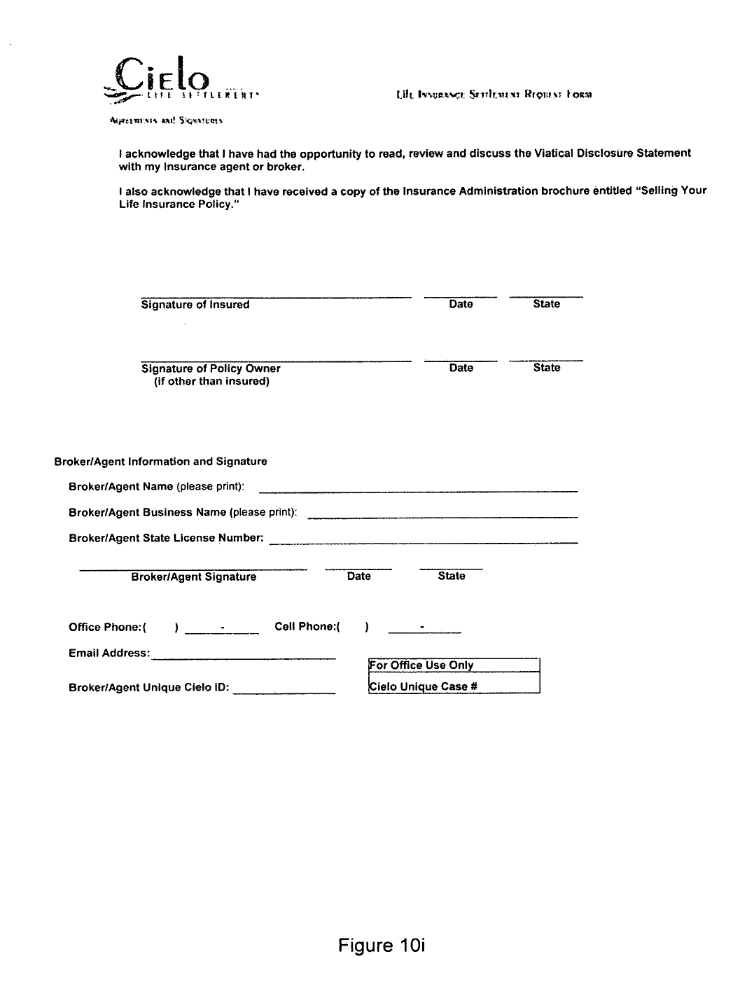

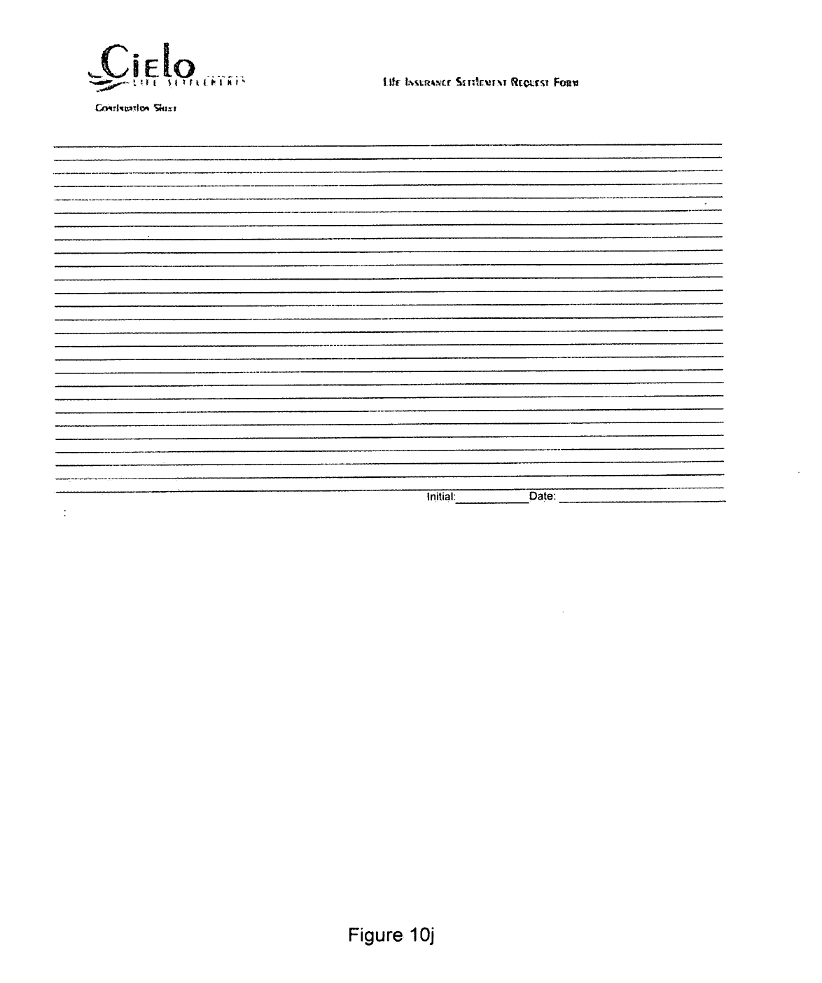

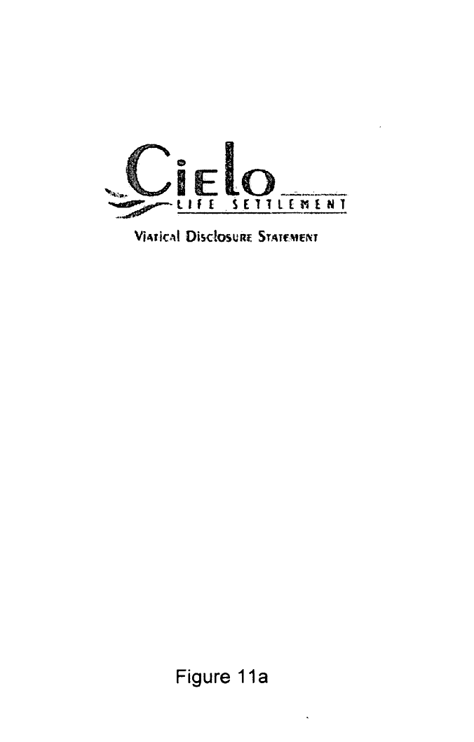

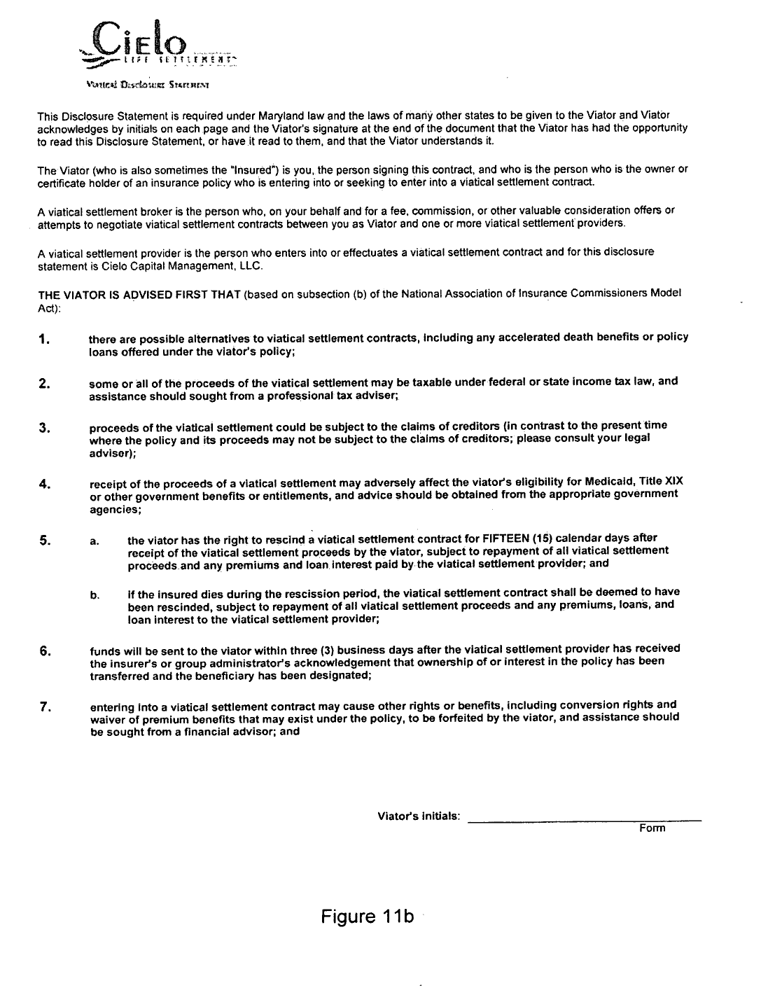

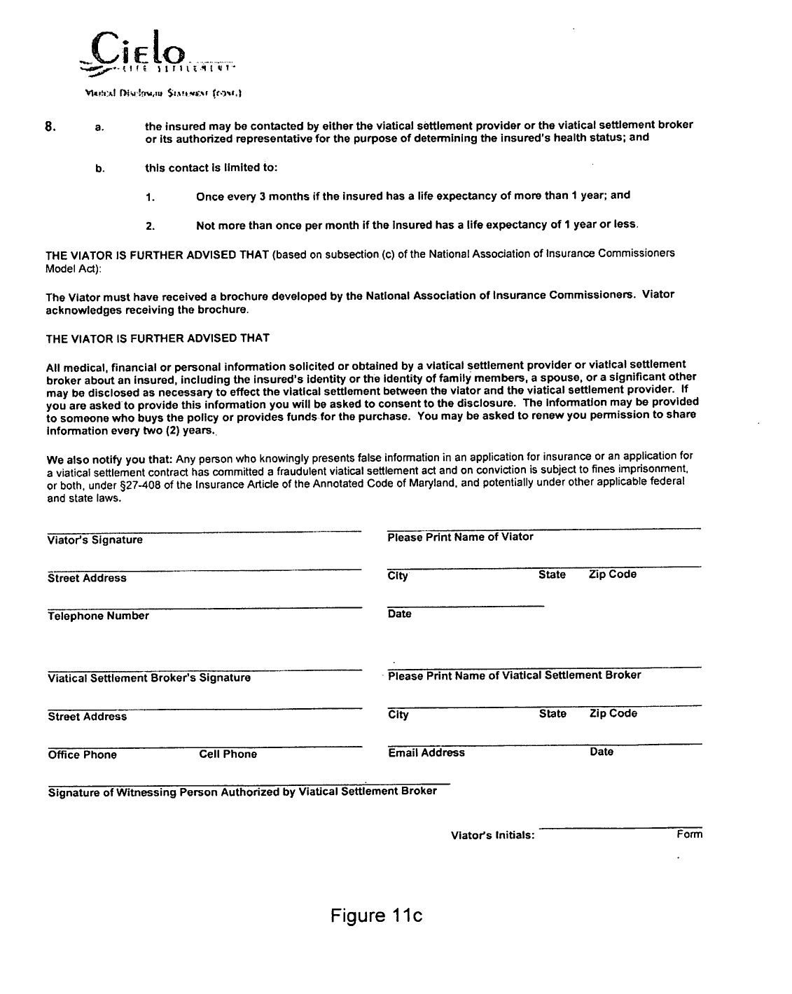

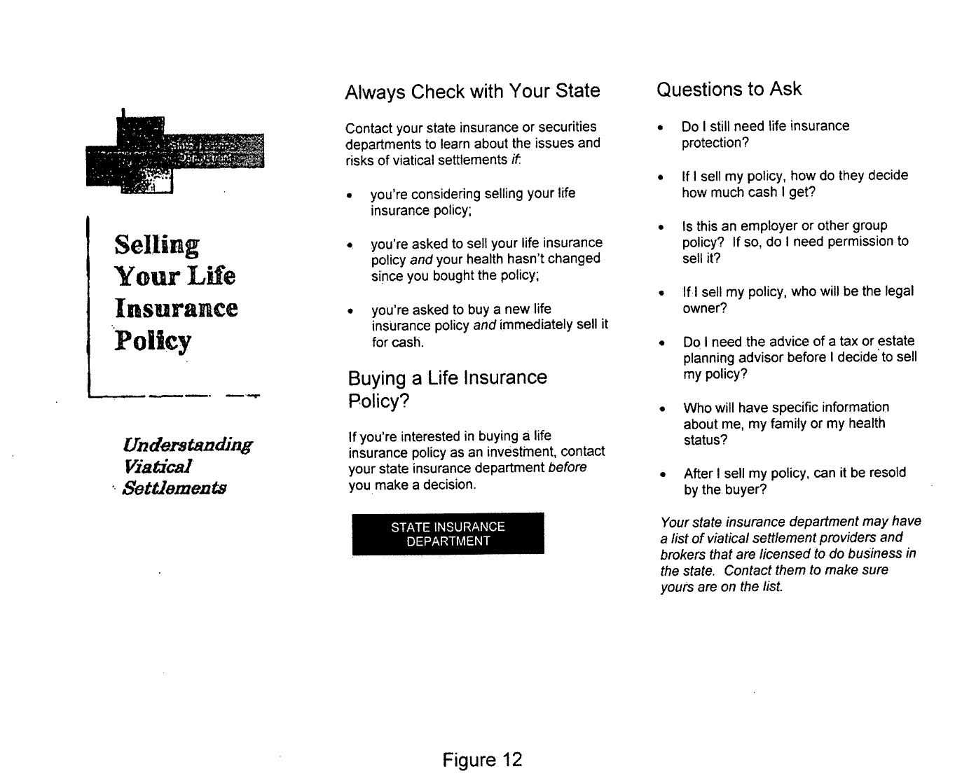

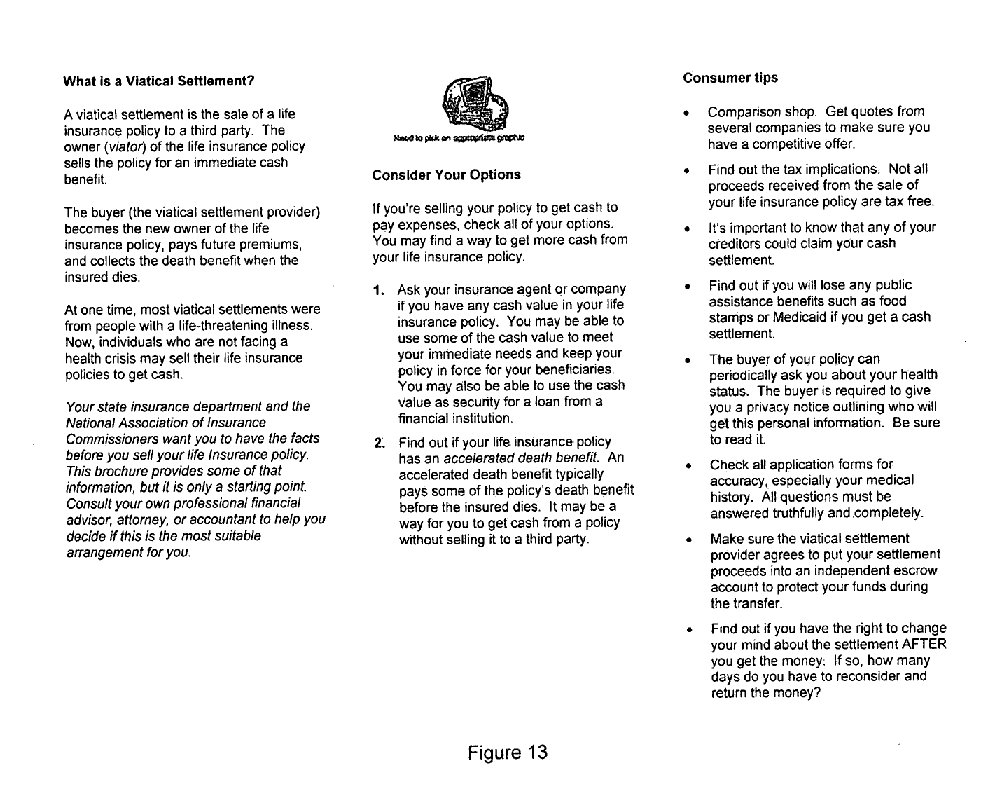

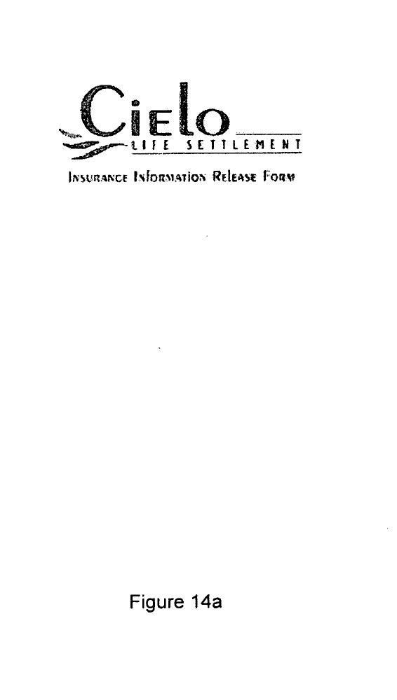

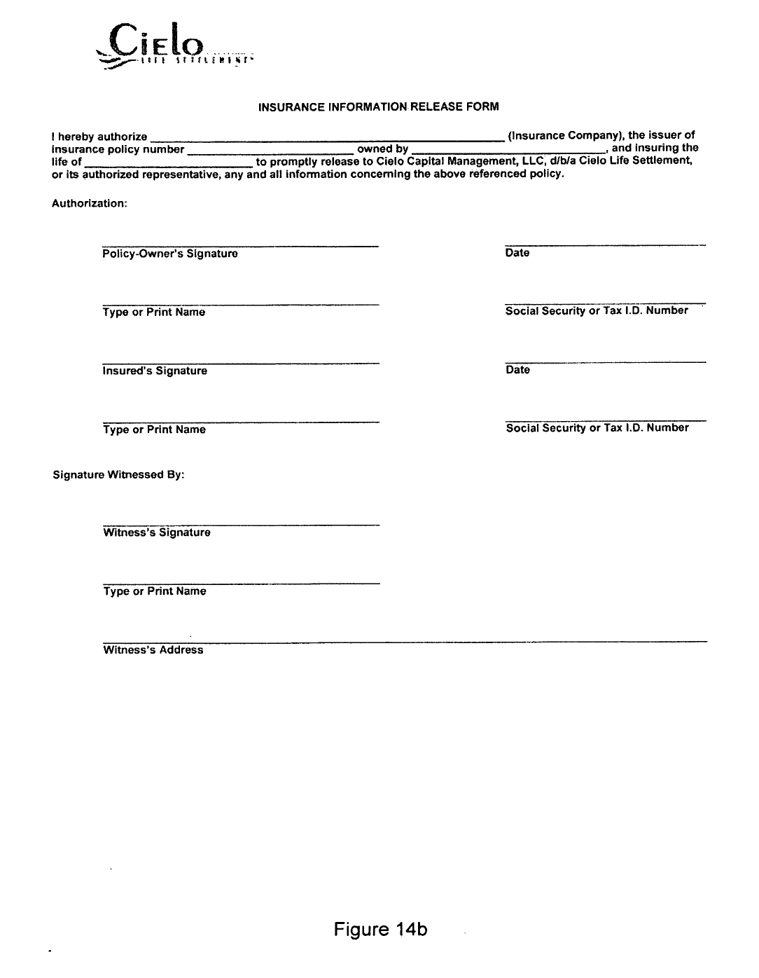

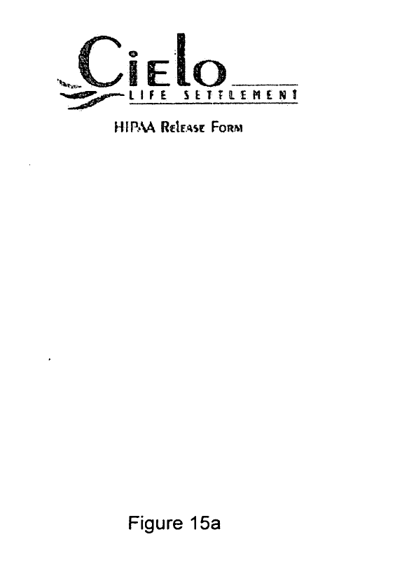

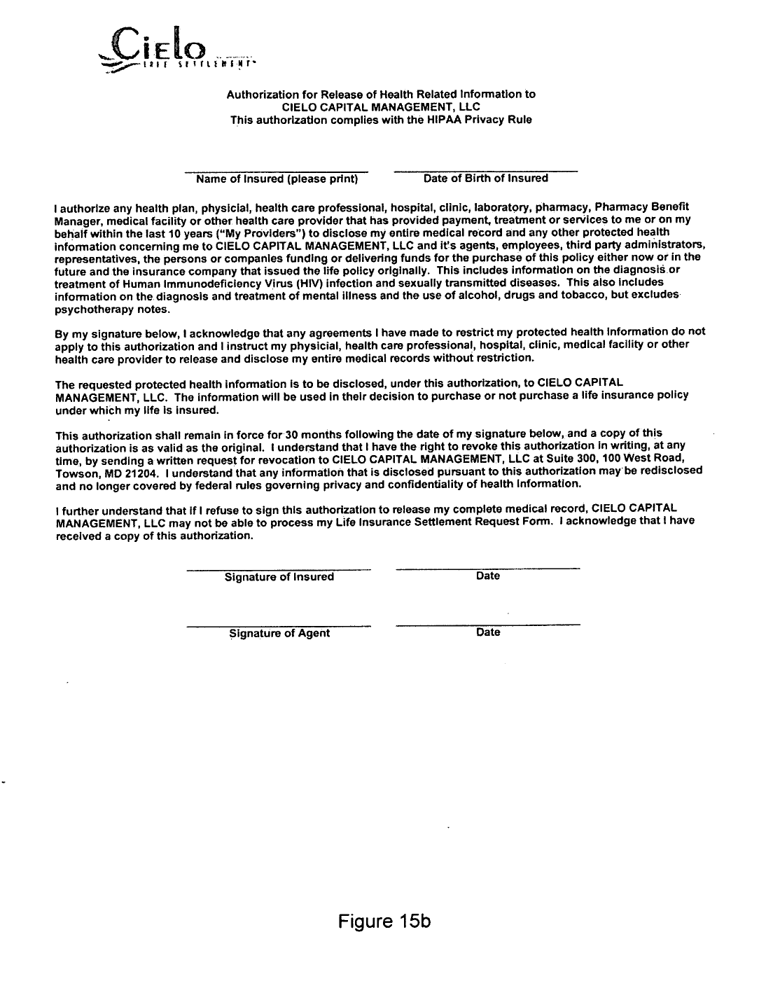

Screen shots of various web pages provided by the server 110 in an embodiment of the invention are illustrated in FIGS. 3-10. These figures should be understood to be exemplary only and should not be understood to limit the invention. FIG. 3 illustrates an opening web page and FIG. 4 illustrates a web page that explains the life settlement process. FIG. 5 illustrates a web page that explains what forms must be submitted in order for an application for a life settlement to be considered and provides a link to upload the necessary forms to the server 110. FIGS. 6a-6c illustrate a Frequently Asked Question page provided by the server 110. FIG. 7 illustrates a Contact web page. FIG. 8 illustrates a New Account web page that a user must complete in order to use the upload feature of FIG. 5. FIG. 9 illustrates a Secure File Upload page pointed to by the link of FIG. 5 discussed above. FIGS. 10a-10j illustrate a questionnaire provided by the server 110 in some embodiments. In other embodiments, the questionnaire includes an abbreviated medical section as discussed above. FIGS. 11a-11c illustrate a viatical disclosure statement provided by the server 110. FIGS. 12 and 13 illustrate an informational form provided by the server 110. FIGS. 14a-14b illustrate an insurance policy release form, and FIG. 15 illustrates a medical insurance release form provided by the server 110. It should be understood that the pages shown in FIGS. 5, 8, and 9, and the forms illustrated in FIGS. 10-15 may not be made available to the public by the server in some embodiments. In such embodiments, only an agent or other authorized representative may have access to the web pages and forms in FIGS. 5 and 8-15, or the distribution and uploading of forms may be done via mail or courier and uploaded via the operator terminal 150 of FIG. 1.

It will be apparent to those of skill in the art that numerous variations in addition to those discussed above are also possible. Therefore, while the invention has been described with respect to certain specific embodiments, it will be appreciated that many modifications and changes may be made by those skilled in the art without departing from the spirit of the invention. It is intended therefore, by the appended claims to cover all such modifications and changes as fall within the true spirit and scope of the invention.

Furthermore, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method for making a life settlement comprising the steps of:
receiving initial information pertaining to a life settlement application, the initial information including customer identification information, life insurance policy information, and medical information concerning an insured person whose life is covered by a life insurance policy to which the life insurance policy information pertains;
performing an initial verification of a portion of the medical information, the initial verification including an act selected from the group consisting of conducting a telephone interview with a physician treating the insured person; sending a-written questionnaire to a physician treating the insured person; conducting a telephonic interview with the insured person, and querying a pharmacy database to determine prescription drug usage by the insured person;
making a conditional life settlement offer based at least in part on the initial verification;
verifying additional information if the conditional life settlement offer is accepted, the additional information including at least insured person medical information other than that which was verified in the initial verification; and
completing the life settlement based on a result of the verifying step.

2. The method of claim 1, in which at least a portion of the life insurance policy information is verified as part of the initial verification.

3. The method of claim 1, in which all of the life insurance policy information is verified in the verifying step.

4. The method of claim 1, in which the additional information includes insured person medical information that is unrelated to a life threatening illness.

5. The method of claim 1, in which the additional information includes an attending physician statement from the insured person's primary medical doctor.

6. The method of claim 1, in which the insured person has a life threatening illness.

7. The method of claim 1, in which a face value of the life insurance policy is less than $500,000.

8. The method of claim 1, in which a face value of the life insurance policy is less than $250,000.

9. The method of claim 1, in which additional insured person information is gathered during the initial verification.

10. The method of claim 9, in which the additional insured person information comprises information related to a medical condition associated with the insured person.

11. The method of claim 1, in which a portion of the initial information is gathered during a phone interview the insured person.

12. A system for processing an application for a life settlement, the system comprising:
a server; and
a database connected to the server;
wherein the server is configured to perform the steps of
receiving initial information pertaining to a life settlement application, the initial information including customer identification information, life insurance policy information, and medical information concerning an insured person whose life is covered by a life insurance policy to which the life insurance policy information pertains;
performing an initial verification of a portion of the medical information, the initial verification including an act selected from the group consisting of conducting a telephone interview with a physician treating the insured person; sending a written questionnaire to a physician treating the insured person; conducting a telephonic interview with the insured person, and querying a pharmacy database to determine prescription drug usage by the insured person;
generating a conditional life settlement offer based at least in part on the initial verification;
verifying additional information if the conditional life settlement offer is accepted, the additional information including at least insured person medical information other than that which was verified in the initial verification; and
generating an indication that the life settlement should be completed based on a result of the verifying step.

13. The system of claim 12, in which at least a portion of the life insurance policy information is verified as part of the initial verification.

14. The system of claim 12, in which the additional information includes insured person medical information that is unrelated to a life threatening illness.

15. The system of claim 12, in which the additional information includes an attending physician statement from the insured person's primary medical doctor.

16. The system of claim 12, in which the insured person has a life threatening illness.

17. The system of claim 12, in which a face value of the life insurance policy is less than $500,000.

18. The system of claim 12, in which a face value of the life insurance policy is less than $250,000.

19. The system of claim 12, further comprising an operator terminal attached to the server, wherein a portion of the initial information is obtained by an operator in a phone interview with the insured person and is received by the server from the operator terminal.

20. The system of claim 12, in which all of the life insurance policy information is verified in the verifying step.
